(19) United States
(12) Patent Application Publication
(10) Pub. No.: US 2008/0186429 A1
(43) Pub. Date: Aug. 7, 2008

(54) LIGHT DIFFUSER PLATE SURFACE EMISSION LIGHT SOURCE APPARATUS AND LIQUID CRYSTAL DISPLAY

(75) Inventors: Toyohiro Hamamatsu, Niihama-shi (JP); Takashi Sakamoto, Niihama-shi (JP); Tomohiro Sato, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/025,134

(22) Filed: Feb. 4, 2008

(30) Foreign Application Priority Data
Feb. 2, 2007 (JP) 2007-023684

(51) Int. Cl. G02B 5/02; G02F 1/1335

(52) U.S. Cl. 349/64; 362/355

(57) ABSTRACT

To provide a light diffuser plate which is lightweight and has sufficient strength and is not deformed by heat or humidity, and also has sufficient surface hardness and is also excellent in scratch resistance.

A light diffuser plate 3 of the present invention comprises a base layer 8 which is made of a resin composition containing light diffusing particles in an amount of 0.1 parts by mass or more and less than 5 parts by mass based on 100 parts by mass of a propylene polymer, and a surface layer 9 which is integrally laminated on one or both surfaces of the base layer 8, and the surface layer 9 is made of a resin composition containing particles having a volume average particle diameter of 10 to 200 μm in an amount of 5 to 50 parts by mass based on 100 parts by mass of a propylene polymer.

### BACKGROUND OF THE INVENTION

1. Field of the Invention

The present invention relates to a light diffuser plate having sufficient surface hardness, and a surface emission light source apparatus and a liquid crystal display apparatus which are free from scratches of the light diffuser plate and have high quality.

In this specification and the claims, the term “volume average particle diameter” means the particle diameter of particles for which the integrated volume accounts to 50% of the total volume after measuring the particle diameter and the volume of all particles and the volume is integrated in order of increasing particle diameter.

2. Description of the Related Art

Such a liquid crystal display apparatus is known, for example, that has a surface emission light source apparatus disposed as the backlight on the back side of a liquid crystal panel (image display section) that comprises a liquid crystal cell. For the surface emission light source apparatus used as the backlight, such a constitution is known as a plurality of light sources is disposed in a lamp box (casing), and a light diffuser plate is disposed on the front side of the light sources (refer to Japanese Unexamined Patent Publication (Kokai) No. 2004-170937).

A light diffuser plate made of an acrylic resin or a polycarbonate resin has often been used as the light diffuser plate.

It is required that the light diffuser plate to be used in the surface emission light source apparatus is more lightweight and is less likely to be broken, and also it is not deformed by heat from the light source or humidity and is less likely to be scratched.

However, the above conventional light diffuser plate can not satisfy all these required characteristics.

### SUMMARY OF THE INVENTION

The present invention has been conceived with the technical background described above, and has an object of providing a light diffuser plate which is more lightweight and has sufficient strength and is not deformed by heat or humidity, and also has sufficient surface hardness and is also excellent in scratch resistance, and a surface emission light source apparatus and a liquid crystal display apparatus which are free from scratches of the light diffuser plate and have high quality, and are also lightweight.

In order to achieve the objects described above, the present invention provides the following means.

[1] A light diffuser plate comprising:

a base layer which is made of a resin composition containing light diffusing particles in an amount of 0.1 parts by mass or more and less than 5 parts by mass based on 100 parts by mass of a propylene polymer, and

a surface layer which is integrally laminated on one or both surfaces of the base layer, wherein

the surface layer is made of a resin composition containing particles having a volume average particle diameter of 10 to 200 μm in an amount of 5 to 50 parts by mass based on 100 parts by mass of a propylene polymer.

[2] The light diffuser plate according to paragraph 1, wherein the resin composition constituting the surface layer further contains an ultraviolet absorber in an amount of 0.1 to 5 parts by mass based on 100 parts by mass of the propylene polymer.
[3] The light diffuser plate according to paragraph 1 or 2, wherein the volume average particle diameter of the light diffusing particles is 0.5 μm or more and less than 10 μm.
[4] The light diffuser plate according to any one of paragraphs 1 to 3, wherein the thickness of the surface layer is from 10 to 500 μm and the entire thickness is from 1 to 3 μm.
[5] A surface emission light source apparatus comprising the light diffuser plate according to any one of paragraphs 1 to 4 and a plurality of light sources disposed on the back side of the light diffuser plate.
[6] A liquid crystal display apparatus comprising the light diffuser plate according to any one of paragraphs 1 to 4, a plurality of light sources disposed on the back side of the light diffuser plate, and a liquid crystal panel disposed on the front side of the light diffuser plate.

In the light diffuser plate of the invention of [1], since the base layer is made of a resin composition wherein light diffusing particles are dispersed in a propylene polymer, the light diffuser plate has a light diffusion function and is lightweight and is less likely to be broken, and is also excellent in heat resistance and humidity resistance and is not deformed by heat or humidity. Furthermore, the surface laminated integrally on one or both surfaces of the base layer is made of a resin composition containing particles having a volume average particle diameter of 10 to 200 μm in an amount of 5 to 50 parts by mass based on 100 parts by mass of a propylene polymer, and thus the light diffuser plate has sufficient surface hardness and is excellent in scratch resistance. Therefore, for example, even if the light diffuser plate is contacted with other components during assembly of a surface emission light source apparatus and a liquid crystal display apparatus using the light diffuser plate, the surface is less likely scratched, thus making it possible to provide a surface emission light source apparatus and a liquid crystal display apparatus which have high quality.

In the invention of [2], since the resin composition constituting the surface layer further contains an ultraviolet absorber in an amount of 0.1 to 5 parts by mass based on 100 parts by mass of the propylene polymer, light resistance of the light diffuser plate can be improved.

In the invention of [3], since the volume average particle diameter of the light diffusing particles is 0.5 μm or more and less than 10 μm, light diffusion performance can be further improved.

In the invention of [4], since the thickness of the surface layer is from 10 to 500 μm and the entire thickness is from 1 to 3 μm, a light diffuser plate having more sufficient surface hardness and sufficient mechanical strength can be provided.

In the invention of [5], a surface emission light source apparatus, which is free from scratches of the light diffuser plate, and also has high quality and is lightweight, is provided.

In the invention of [6], a liquid crystal display apparatus, which is free from scratches of the light diffuser plate, and also has high quality and is lightweight, is provided.

### BRIEF DESCRIPTION OF THE DRAWINGS

FIG. 1 a schematic view showing one embodiment of the liquid crystal display apparatus according to the present invention.

FIG. 2 is a sectional view showing one embodiment of the light diffuser plate according to the present invention.

### BRIEF DESCRIPTION OF THE REFERENCE NUMERALS

1 Surface emission light source apparatus
2 Light source
3 Light diffuser plate
8 Base layer
9 Surface layer
20 Liquid crystal panel
30 liquid crystal display apparatus
S Thickness of light diffuser plate
T Thickness of surface layer

### DETAILED DESCRIPTION OF THE INVENTION

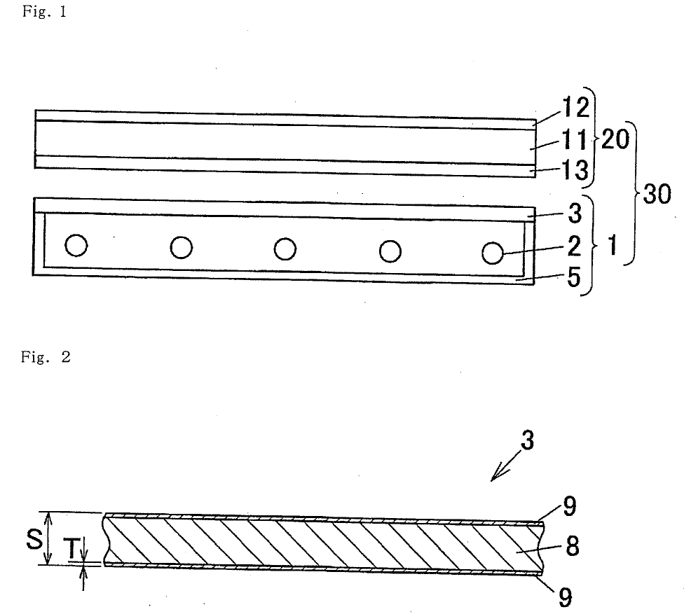

One embodiment of the liquid crystal display apparatus according to the present invention is shown in FIG. 1. In FIG. 1, reference numeral (30) denotes a liquid crystal display apparatus, (11) denotes a liquid crystal cell, (12), (13) denote polarizer plates and (1) denotes a surface emission light source apparatus (backlight). Polarizer plates (12), (13) are disposed on top and bottom sides of the liquid crystal cell (11) and a liquid crystal panel (20) as an image display section is composed of these constituent members (11), (12), (13). As the liquid crystal cell (11), those capable of displaying a color image are preferably use.

The surface emission light source apparatus (1) is disposed on the lower surface side (back surface side) of the bottom side polarizer plate (13) of the liquid crystal panel (20). That is, this liquid crystal display apparatus (30) is a transmission type liquid crystal display apparatus.

The surface emission light source apparatus (1) comprises a lamp box (5) having a rectangular shape in plan view and having a shape of thin box that is open on the top surface side (front surface side), a plurality of linear light sources (2) disposed at a distance from each other in the lamp box (5), and a light diffuser plate (3) disposed on the upper side (front surface side) of the plurality of linear light sources (2). The light diffuser plate (3) is secured onto the lamp box (5) so as to close the opening on the front side of the lamp box (5). On the inside surface of the lamp box (5), a light reflection layer (not shown) is formed. The light source (2) is not specifically limited and, for example, a cold cathode ray tube and a light emitting diode (LED) are used.

As shown in FIG. 2, the light diffuser plate (3) comprises a base layer (8) and surface layers (9), (9) which are integrally laminated on both surfaces of the base layer. The base layer (8) is made of a resin composition containing light diffusing particles in an amount of 0.1 parts by mass or more and less than 5 parts by mass based on 100 parts by mass of a propylene polymer, and the surface layer (9) is made of a resin composition containing particles having a volume average particle diameter of 10 to 200 μm in an amount of 5 to 50 parts by mass based on 100 parts by mass of a propylene polymer.

Since the base layer (8) of the light diffuser plate (3) is made of a resin composition wherein light diffusing particles (A) are dispersed in a propylene polymer, a sufficient light diffusion function is obtained and also the light diffuser plate is lightweight and is excellent in mechanical strength and thus it is less likely to be broken. The light diffuser plate is excellent in heat resistance and moisture resistance and thus it is not deformed by heat or humidity. Furthermore, since the surface layer (9) laminated on both surfaces of the base layer (8) is made of a resin composition containing particles having a volume average particle diameter of 10 to 200 μm in an amount of 5 to 50 parts by mass based on 100 parts by mass of a propylene polymer, the light diffuser plate (3) has sufficient surface hardness and is excellent in scratch resistance. Therefore, a surface emission light source apparatus (1) and a liquid crystal display apparatus (30), which are constituted using the light diffuser plate (3), have high quality because the surface is less likely to be scratched even if the light diffuser plate (3) is contacted with other components during assembly.

In the present invention, the base layer (8) is made of a resin composition containing light diffusing particles (A) in an amount of 0.1 parts by mass or more and less than 5 parts by mass based on 100 parts by mass of a propylene polymer. When the amount of light diffusing particles (A) is less than 0.1 parts by mass, a sufficient light diffusion effect is not obtained. When the amount of light diffusing particles is 5 parts by mass or more, there is a fear that the mechanical strength decreases. The base layer (8) is preferably made of a resin composition containing light diffusing particles (A) in an amount of 0.1 parts by mass or more and 3 parts by mass or less based on 100 parts by mass of a propylene polymer.

The volume average particle diameter of the light diffusing particles (A) is preferably 0.5 μm or more and 35 μm or less. When the volume average particle diameter is within the above range, sufficient light diffusion performance can be obtained. The lower limit of the volume average particle diameter of the light diffusing particles (A) is preferably 0.7 μm or more. Also, the upper limit of the volume average particle diameter is preferably 20 μm or less, and more preferably less than 10 μm.

If necessary, the resin composition constituting the base layer (8) may contain, in addition to additives such as ultraviolet absorbers, thermal stabilizers, antioxidants, weathering agents, photostabilizers, fluorescent whitening agents, processing stabilizers and nucleating agents, resins other than a propylene polymer.

The surface layer (9) is made of a resin composition containing particles (B) having a volume average particle diameter of 10 to 200 μm in an amount of 5 to 50 parts by mass based on 100 parts by mass of a propylene polymer. When the amount of particles is less than 5% by mass, sufficient surface hardness is not obtained. In contrast, when the amount of particles is more than 50% by mass, there arises a problem that it becomes difficult to produce the light diffuser plate. The surface layer (9) is preferably made of a resin composition containing particles (B) having a volume average particle diameter of 10 to 200 μm in an amount of 8 to 40 parts by mass based on 100 parts by mass of a propylene polymer.

The volume average particle diameter of the particles (B) contained in the resin composition constituting the surface layer (9) is within a range from 10 to 200 μm. When the volume average particle diameter of the particles is less than 10 μm, sufficient surface hardness can not be obtained. When the volume average particle diameter is more than 200 μm, there arises a problem that the particles (B) are not uniformly distributed on the surface layer (9), resulting in poor appearance. The volume average particle diameter of the particles (B) contained in the resin composition constituting the surface layer (9) is preferably within a range from 20 to 150 μm.

The particles (B) may have a refractive index which is the same as or different from that of a propylene polymer. For example, the particles may be inorganic particles such as glass particles, glass fibers, silica particles, aluminum hydroxide particles, calcium carbonate particles, barium sulfate particles, titanium oxide particles and talc, or organic particles such as styrenic polymer particles, acrylic polymer particles and siloxane-based polymer particles. As the particles (B), the same light diffusing particles (A) as those contained in the resin composition constituting the base layer (8) may be used. Preferably, the particles (B) may be styrenic polymer particles, acrylic polymer particles or acryl-styrene composite particles comprising a core layer made of an acrylic resin and a shell layer made of a styrenic resin. Among them, the acryl-styrene composite particles are particularly preferable because the particles (B) are less likely to be discolored by ultraviolet light emitted from the light source and because the particles (B) are less likely to be removed from the surface layer during molding operation.

Preferably, the resin composition constituting the surface layer (9) further contains an ultraviolet absorber in an amount of 0.1 to 5 parts by mass based on 100 parts by mass of the propylene polymer. Namely, the surface layer is preferably made of a resin composition containing particles having a volume average particle diameter of 10 to 200 μm in an amount of 5 to 50 parts by mass and an ultraviolet absorber in an amount of 0.1 to 5 parts by mass based on 100 parts by mass of a propylene polymer. When the amount of the ultraviolet absorber is 0.1 parts by mass or more, sufficient light resistance can be ensured, and also when the amount is 5 parts by mass or less, coloration due to the addition of the ultraviolet absorber can be suppressed. The resin composition constituting the surface layer (9) preferably contains the ultraviolet absorber in an amount of 0.2 to 3 parts by mass based on 100 parts by mass of the propylene polymer.

The ultraviolet absorber is not specifically limited, but those capable of absorbing light having a wavelength within a range from 250 to 380 nm are preferably used and those having a maximum absorption wavelength within such a wavelength range are particularly preferable. Examples of the ultraviolet absorber include, but are not limited to, malonate ester-based ultraviolet absorbers, cinnamate ester-based ultraviolet absorbers, oxalanilide ultraviolet absorbers, benzophenone-based ultraviolet absorbers, salicylate-based ultraviolet absorbers, nickel complex salt-based ultraviolet absorbers, benzoate-based ultraviolet absorbers and benzotriazole-based ultraviolet absorbers.

If necessary, the resin composition constituting the surface layer (9) may contain, in addition to additives such as hindered amines, thermal stabilizers, antioxidants, weathering agents, photostabilizers, fluorescent whitening agents, processing stabilizers and nucleating agents, resins other than a propylene polymer.

The thickness (T) of the surface layer (9) is usually from 10 to 500 μm. When the thickness of the surface layer is 10 μm or more, sufficient surface hardness is obtained, and also when the thickness is 500 μm or less, an increase in cost can be suppressed. The thickness (T) of the surface layer (9) is preferably from 20 to 300 μm, and particularly preferably from 50 to 100 μm. Thus, the thickness (S) of the light diffuser plate (3) is usually set within a range from 1 to 3 mm (refer to FIG. 2).

In the above embodiment, the configuration wherein the surface layers (9), (9) are integrally laminated on both surfaces of the base layer (8) was employed. However, the configuration is not specifically limited to such a configuration, and the configuration wherein the surface layer (9) is integrally laminated on one surface of the base layer (8) may be employed.

In the present invention, the propylene polymer constituting the base layer (8) and the surface layer (9) may be homopropylene obtained by polymerizing propylene alone, or a copolymer of propylene and a copolymerization component which is copolymerizable with propylene. The content of a propylene unit in the propylene polymer is preferably 98% by mass or more because sufficient rigidity is obtained. The copolymerization component includes, but is not limited to, α-olefins such as ethylene or 1-butene.

The light diffusing particles (A) contained in the base layer (8) are not specifically limited as long as they are particles having a refractive index which is different from that of the propylene polymer and can diffuse light transmitting the light diffuser plate when the particles are contained in the state of being dispersed. For example, the particles may be inorganic particles such as glass particles, glass fibers, silica particles, aluminum hydroxide particles, calcium carbonate particles, barium sulfate particles, titanium oxide particles and talc, or organic particles such as styrenic polymer particles, acrylic polymer particles and siloxane-based polymer particles.

The styrenic polymer particles include, for example, particles of a polymer containing a styrenic monofunctional monomer unit as a main component, namely, a polymer containing 50% by mass or more of a styrenic monofunctional monomer unit. The particles of the polymer containing 50% by mass or more of a styrenic monofunctional monomer unit may be particles of a polymer wherein the entire monomer unit (100% by mass) is a styrenic monofunctional monomer unit, or may be particles of a copolymer of a styrenic monofunctional monomer unit and a monofunctional monomer which is copolymerizable with the styrenic monofunctional monomer.

The styrenic monofunctional monomer unit is a compound which has a styrene skeleton and also has one radical-polymerizable double bond in the molecule. Specific examples thereof include, in addition to styrene, substituted styrenes. Examples of the substituted styrenes include halogenated styrenes such as chlorostyrene and bromostyrene, and alkylstyrenes such as vinyltoluene and α-methylstyrene.

The monofunctional monomer, which is copolymerizable with the styrenic monofunctional monomer, is a compound which has one radical-polymerizable double bond and is copolymerizable with the styrenic monofunctional monomer through the double bond. Specific examples thereof include methacrylate esters such as methyl methacrylate, ethyl methacrylate, butyl methacrylate, cyclohexyl methacrylate, phenyl methacrylate, benzyl methacrylate, 2-ethylhexyl methacrylate and 2-hydroxyethyl methacrylate; and acrylate esters such as methyl acrylate, ethyl acrylate, butyl acrylate, cyclohexyl acrylate, phenyl acrylate, benzyl acrylate, 2-ethylhexyl acrylate and 2-hydroxyethyl acrylate; and acrylonitrile. These monofunctional monomers may be used alone, or two or more kinds of them may be used in combination. As the monofunctional monomer which is copolymerizable with the styrenic monofunctional monomer, methacrylate esters are preferably used.

The styrenic polymer particles may be particles of a copolymer of a styrenic monofunctional monomer and a polyfunctional monomer which is copolymerizable with the styrenic monofunctional monomer. The polyfunctional monomer is a compound which has two or more radical-polymerizable doubles bonds in the molecule and is copolymerizable with the styrenic monofunctional monomer through the double bonds. Examples of the polyfunctional monomer include methacrylates of polyhydric alcohols, such as 1,4-butanediol dimethacrylate, neopentyl glycol dimethacrylate, ethylene glycol dimethacrylate, diethylene glycol dimethacrylate, tetraethylene glycol dimethacrylate, propylene glycol dimethacrylate, tetrapropylene glycol dimethacrylate, trimethylolpropane trimethacrylate and pentaerythritol tetramethacrylate; acrylates of polyhydric alcohols, such as 1,4-butanediol diacrylate, neopentyl glycol diacrylate, ethylene glycol diacrylate, diethylene glycol diacrylate, tetraethylene glycol diacrylate, propylene glycol diacrylate, tetrapropylene glycol diacrylate, trimethylolpropane triacrylate and pentaerythritol tetraacrylate; and aromatic polyfunctional compounds such as divinylbenzene and diallyl phthalate. These polyfunctional monomers may be used alone, or two or more kinds of them may be used in combination.

The acrylic polymer particles include, for example, particles of a polymer containing an acrylic monofunctional monomer unit as a main component, namely, a polymer containing 50% by mass or more of an acrylic monofunctional monomer unit. The particles of the polymer containing 50% by mass or more of an acrylic monofunctional monomer unit may be particles of a polymer wherein the entire monomer unit (100% by mass) is a styrenic monofunctional monomer unit, or may be particles of a copolymer of an acrylic monofunctional monomer unit and a monofunctional monomer which is copolymerizable with the acrylic monofunctional monomer.

Examples of the acrylic monofunctional monomer include acrylic acid, methacrylic acid, acrylate esters and methacrylate esters. Examples of the acrylate esters include, but are not limited to, methyl acrylate, ethyl acrylate, butyl acrylate, cyclohexyl acrylate, phenyl acrylate, benzyl acrylate, 2-ethylhexyl acrylate and 2-hydroxyethyl acrylate. Examples of the methacrylate esters include, but are not limited to, methyl methacrylate, ethyl methacrylate, butyl methacrylate, cyclohexyl methacrylate, phenyl methacrylate, benzyl methacrylate, 2-ethylhexyl methacrylate and 2-hydroxyethyl methacrylate. These acrylic monofunctional monomers may be used alone, or two or more kinds of them may be used in combination.

The monofunctional monomer, which is copolymerizable with the acrylic monofunctional monomer, is a compound which has one radical polymerizable double bond in the molecule and is copolymerizable with the acrylic monofunctional monomer through the double bond. Specific examples thereof include, in addition to styrene, substituted styrenes, for example, halogenated styrenes such as chlorostyrene and bromostyrene, and alkylstyrenes such as vinyltoluene and α-methylstyrene. The monofunctional monomer further includes acrylonitrile. These monofunctional monomers may be used alone, or two or more kinds of them may be used in combination.

The acrylic polymer particles may be particles of an acrylic monofunctional monomer and a copolymer which is copolymerizable with the acrylic monofunctional monomer. The polyfunctional monomer is a compound which has two or more double bonds, which are copolymerizable with the acrylic monofunctional monomer, in the molecule and is copolymerizable with the acrylic monofunctional monomer through the double bond. Examples of the polyfunctional monomer include the same methacrylates of polyhydric alcohols, acrylates of polyhydric alcohols and aromatic polyfunctional compounds as those listed as for the styrenic polymer particles. These polyfunctional monomers may be used alone, or two or more kinds of them may be used in combination.

The acrylic polymer particles may be particles of a tercopolymer obtained by copolymerizing an acrylic monofunctional monomer, a monofunctional monomer which is copolymerizable with the acrylic monofunctional monomer, and a polyfunctional monomer which is also copolymerizable with the acrylic monofunctional monomer.

The siloxane-based polymer particles are composed of a polymer produced, for example, by a method of hydrolyzing chlorosilanes and condensing the resulting hydrolyzate. Examples of the chlorosilanes include dimethyldichlorosilane, diphenyldichlorosilane, phenylmethyldichlorosilane, methyltrichlorosilane and phenyltrichlorosilane. The siloxane-based polymer may be crosslinked. The siloxane-based polymer may be crosslinked by reacting with a peroxide such as benzoyl peroxide, 2,4-dichlorobenzyl peroxide, p-chlorobenzoyl peroxide, dicumyl peroxide or di-t-butyl-2,5-dimethyl-2,5-di(t-butylperoxy)hexane peroxide. When a structure having a silanol group at the end is obtained, the siloxane-based polymer may be condensation-crosslinked with alkoxysilanes. The crosslinked siloxane-based polymer preferably has a structure wherein about two to three organic groups are bonded per one silicon atom. Such a siloxane-based polymer is a polymer which is also called a silicone rubber or a silicone resin. As the siloxane-based polymer, those in the form of a solid at normal temperature are preferably used.

The siloxane-based polymer particles can be obtained by grinding the siloxane-based polymer. The siloxane-based polymer particles may be obtained as granular particles by curing a curable polymer containing a linear organosiloxane block or a composition thereof in a sprayed state (refer to Japanese Unexamined Patent Publication (Kokai) No. 59-68333). Also, granular particles may be obtained by subjecting an alkyltrialkoxysilane or a partially hydrolyzed condensate to a hydrolytic condensation in an aqueous solution of ammonia or amines (refer to Japanese Unexamined Patent Publication (Kokai) No. 60-13813).

The light diffuser plate (3) of the present invention can be produced by a method such as a coextrusion molding method, a lamination method, a thermal bonding method, a solvent bonding method, a polymerization bonding method, a cast polymerization method or a surface coating method.

When the light diffuser plate (3) is produced by the coextrusion molding method, a resin composition constituting the base layer (8) and a resin composition constituting the surface layer (9) may be coextruded. For example, the resin composition constituting the base layer (8) and the resin composition constituting the surface layer (9) are separately heated using a different extruder and extruded through a die for coextrusion while melt-kneading, thereby integrating both of them. As the extruder, a single screw extruder and a twin screw extruder can be used. As the die for coextrusion, for example, a feed block die and a multi-manifold die can be used. Both resin compositions are integrally molded by extruding through a die and then cooled by interposing between cooling rolls, and thus the light diffuser plate (3) can be obtained.

When the light diffuser plate (3) is produced by the lamination method, a resin composition for formation of a surface layer, which is in a molten state while heating, is laminated on one or both surfaces of the preliminarily formed base layer (8). After lamination, the resin composition for formation of a surface layer is solidified by cooling, thereby integrally laminating a surface layer (9) on one or both surfaces of the base layer (8) to obtain the objective light diffuser plate (3).

When the light diffuser plate (3) is produced by the thermal bonding method, a surface layer (9) is formed into a film and pressed on the surface of the preliminarily formed base layer (8) while heating. When pressed after heating to a temperature which is higher than a softening point of a propylene polymer, the surface layer (9) and the base layer (8) are integrally laminated by heat fusion to obtain the objective light diffuser plate (3).

When the light diffuser plate (3) is produced by the solvent bonding method, the formed base layer (8) and the formed surface layer (9) are prepared and a solvent capable of dissolving one or both of these layers is applied on one or both adhesive surfaces, followed by lamination. After lamination, the solvent is vaporized, thereby integrally laminating the surface layer (9) and the base layer (8) to obtain the objective light diffuser plate (3).

When the light diffuser plate (3) is produced by the polymerization bonding method, the formed base layer (8) and the formed surface layer (9) are prepared and a polymerizable adhesive is applied on one or both adhesive surfaces, followed by lamination. After lamination, the polymerizable adhesive is polymerized. The polymerizable adhesive contains a polymerizable monomer and a polymerization initiator, and the polymerization initiator may be a thermopolymerization initiator which initiates polymerization of the monomer by heating, or may be a photopolymerization initiator which initiates polymerization of the monomer by irradiating with light. The polymerizable adhesive is polymerized by heating according to the kind of polymerization initiator used, or irradiating with light. Thus, the surface layer (9) and the base layer (8) are integrally laminated to obtain the objective light diffuser plate (3).

The above methods are exemplary of the invention and the light diffuser plate (3) of the present invention is not limited to those produced by these methods.

The size of the light diffuser plate (3) of the present invention is not specifically limited and is appropriately set according to the size of the objective surface emission light source apparatus (1) and liquid crystal display apparatus (30). The light diffuser plate is best suited for use as a light diffuser plate having the size of 20-inch (measuring 30 cm in length and 40 cm in width) or more.

The light diffuser plate (3), the surface emission light source apparatus (1) and the liquid crystal display apparatus (30) of the present invention are not limited to those of the embodiments described above, and any design modifications within the scope of the claims may be made without deviating from the spirit of the invention.

### EXAMPLES

Examples of the present invention will now be described, although it is understood that the present invention is not limited to these Examples.

### Raw Materials

### (Resin Composition X) Resin Composition Prepared by Mixing the Following Ten Kinds of Components

Propylene-ethylene copolymer (“D101” manufactured by Sumitomo Chemical Co., Ltd., propylene unit content is 99% by mass or more, ethylene unit content is 1% by mass or less): 98.3 parts by mass

Siloxane-based polymer particles (light diffusing particles) (“DY33-719” manufactured by Dow Corning Toray Co. Ltd., volume average particle diameter: 2 to 3 μm): 0.7 parts by mass

Styrene-based polymer particles (light diffusing particles) (“SBX4” manufactured by SEKISUI PLASTICS CO., LTD., volume average particle diameter: 4 μm): 0.7 parts by mass

Sumilizer GA-80 (stabilizer manufactured by Sumitomo Chemical Co., Ltd.): 0.05 parts by mass

Sumilizer TPD (stabilizer manufactured by Sumitomo Chemical Co., Ltd.): 0.05 parts by mass

Sumilizer GP (stabilizer manufactured by Sumitomo Chemical Co., Ltd.): 0.1 parts by mass

LA31 (benzotriazole-based ultraviolet absorber manufactured by ADEKA Corporation): 0.05 parts by mass

LA52 (HALS: hindered amine-based photostabilizer manufactured by ADEKA Corporation): 0.05 parts by mass

NA11 (nucleating agent manufactured by ADEKA Corporation): 0.3 parts by mass

Oxazole-based fluorescent whitening agent (“White Flow PSN conc.” manufactured by SUMIKA COLOR CO., LTD.): 0.0015 parts by mass

### Example 1

The above resin composition X was dry-blended, supplied to a first extruder having a screw diameter of 40 mm and melt-kneaded at a temperature of 210 to 250° C., and then the kneaded mixture was supplied to a feed block.

89.5 parts by mass of a polypropylene-ethylene copolymer (“D101” manufactured by Sumitomo Chemical Co., Ltd.), 10 parts by mass of acrylic polymer particles (particles B) (“XC1A” manufactured by Sumitomo Chemical Co., Ltd., volume average particle diameter: about 30 μm) and 0.5 parts by mass of LA31 (benzotriazole-based ultraviolet absorber manufactured by ADEKA Corporation) were dry-blended, supplied to a second extruder having a screw diameter of 20 mm and melt-kneaded at a temperature of 210 to 250° C., and then the kneaded mixture was supplied to a feed block.

A coextrusion molding operation was carried out at a temperature of 250° C. so that the resin composition X supplied from the first extruder to the feed block would form a base layer (8) and the resin composition supplied from the second extruder to the feed block would form surface layers (9), (9) to produce a light diffuser plate (3) constituted from three layers (base layer 1.9 mm in thickness and two surface layers each 0.05 mm in thickness) measuring 2 mm in thickness.

### Example 2

In the same manner as in Example 1, except for using, as a resin composition (for formation of a surface layer) to be supplied to the second extruder, a resin composition comprising 89.5 parts by mass of a polypropylene-ethylene copolymer (“D101” manufactured by Sumitomo Chemical Co., Ltd.), 10 parts by mass of acryl-styrene composite particles (particles B) (“XX165K” manufactured by SEKISUI PLASTICS CO., LTD., volume average particle diameter: about 30 μm) comprising a core layer made of an acrylic resin and a shell layer made of a styrenic resin and 0.5 parts by mass of LA31 (benzotriazole-based ultraviolet absorber manufactured by ADEKA Corporation), a light diffuser plate (3) was produced.

### Example 3

In the same manner as in Example 1, except for using, as a resin composition (for formation of a surface layer) to be supplied to the second extruder, a resin composition comprising 83.65 parts by mass of a polypropylene-ethylene copolymer (“D101” manufactured by Sumitomo Chemical Co., Ltd.), 15 parts by mass of styrenic polymer particles (particles B) (“XX161K” manufactured by SEKISUI PLASTICS CO., LTD., volume average particle diameter: about 30 μm), 0.5 parts by mass of LA31 (benzotriazole-based ultraviolet ray absorbing agent manufactured by ADEKA Corporation), 0.05 parts by mass of Sumilizer GA-80 (stabilizer manufactured by Sumitomo Chemical Co., Ltd.), 0.05 parts by mass of Sumilizer TPD (stabilizer manufactured by Sumitomo Chemical Co., Ltd.), 0.1 parts by mass of Sumilizer GP (stabilizer manufactured by Sumitomo Chemical Co., Ltd.), 0.3 parts by mass of Tin 1577 (triazine-based ultraviolet absorber manufactured by Ciba-Geigy Limited), 0.05 parts by mass of LA52 (HALS: hindered amine-based photostabilizer manufactured by ADEKA Corporation) and 0.3 parts by mass of NA11 (nucleating agent manufactured by ADEKA Corporation), a light diffuser plate (3) was produced.

### Example 4

In the same manner as in Example 1, except for using, as a resin composition (for formation of a surface layer) to be supplied to the second extruder, a resin composition comprising 83.65 parts by mass of a polypropylene-ethylene copolymer (“D101” manufactured by Sumitomo Chemical Co., Ltd.), 15 parts by mass of acryl-styrene composite particles (particles B) (“XX165K” manufactured by SEKISUI PLASTICS CO., LTD., volume average particle diameter: about 30 μm) comprising a core layer made of an acrylic resin and a shell layer made of a styrenic resin, 0.5 parts by mass of LA31 (benzotriazole-based ultraviolet absorber manufactured by ADEKA Corporation), 0.05 parts by mass of Sumilizer GA-80 (stabilizer manufactured by Sumitomo Chemical Co., Ltd.), 0.05 parts by mass of Sumilizer TPD (stabilizer manufactured by Sumitomo Chemical Co., Ltd.), 0.1 parts by mass of Sumilizer GP (stabilizer manufactured by Sumitomo Chemical Co., Ltd.), 0.3 parts by mass of Tin 1577 (triazine-based ultraviolet absorber manufactured by Ciba-Geigy Limited), 0.05 parts by mass of LA52 (HALS: hindered amine-based photostabilizer manufactured by ADEKA Corporation) and 0.3 parts by mass of NA11 (nucleating agent manufactured by ADEKA Corporation), a light diffuser plate (3) was produced.

### Comparative Example 1

In the same manner as in Example 1, except for using, as a resin composition (for formation of a surface layer) to be supplied to the second extruder, a resin composition comprising 99 parts by mass of a polypropylene-ethylene copolymer (“D101” manufactured by Sumitomo Chemical Co., Ltd.) and 1 part by mass of LA31 (benzotriazole-based ultraviolet absorber manufactured by ADEKA Corporation), a light diffuser plate (3) was produced.

### Comparative Example 2

In the same manner as in Example 1, except for using, as a resin composition (for formation of a surface layer) to be supplied to the second extruder, a resin composition comprising 89.5 parts by mass of a polypropylene-ethylene copolymer (“D101” manufactured by Sumitomo Chemical Co., Ltd.), 10 parts by mass of acrylic polymer particles (“GM0402S” manufactured by GANZ CHEMICAL CO., LTD., volume average particle diameter: about 4 μm) and 0.5 parts by mass of LA31 (benzotriazole-based ultraviolet absorber manufactured by ADEKA Corporation), a light diffuser plate (3) was produced.

### Comparative Example 3

In the same manner as in Example 1, except for using, as a resin composition (for formation of a surface layer) to be supplied to the second extruder, a resin composition comprising 89.5 parts by mass of a polypropylene-ethylene copolymer (“D101” manufactured by Sumitomo Chemical Co., Ltd.), 10 parts by mass of styrenic polymer particles (“SBX4” manufactured by SEKISUI PLASTICS CO., LTD., volume average particle diameter: 4 μm) and 0.5 parts by mass of LA31 (benzotriazole-based ultraviolet absorber manufactured by ADEKA Corporation), a light diffuser plate (3) was produced.

### Measurement of Volume Average Particle Diameter of Light Diffusing Particles (A) and Particles (B)

The volume average particle diameter (D₅₀) of light diffusing particles (A) and particles (B) was measured by a Fraunhofer diffraction method of laser forward-scattered light using a Microtrac Particle Size Analyzer manufactured by NIKKISO CO., LTD. (Model 9220FRA). When measuring, about 0.1 g of particles are dispersed in a methanol solution to obtain a dispersion and, after irradiating the resulting dispersion with ultrasonic wave for 5 minutes, the dispersion was input through a sample input port and measurement was carried out.

Light diffuser plates obtained described above were evaluated by the following evaluation methods. The evaluation results are shown in Table 2.

TABLE 1

| | | Example | Example | Example | Example | Comparative | Comparative | Comparative |
|---|---|---|---|---|---|---|---|---|
| | | 1 | 2 | 3 | 4 | Example 1 | Example 2 | Example 3 |
| Composition | D101 | 89.5 | 89.5 | 83.65 | 83.65 | 99 | 89.5 | 89.5 |
| of surface | XC1A (volume average | 10 | — | — | — | — | — | — |
| layer | particle diameter: 30 μm) | | | | | | | |
| | XX165K (volume average | — | 10 | — | 15 | — | — | — |
| | particle diameter: 30 μm) | | | | | | | |
| | XX161K (volume average | — | — | 15 | — | — | — | — |
| | particle diameter: 30 μm) | | | | | | | |
| | GM0402S (volume average | — | — | — | — | — | 10 | — |
| | particle diameter: 4 μm) | | | | | | | |
| | SBX4 (volume average | — | — | — | — | — | — | 10 |
| | particle diameter: 4 μm) | | | | | | | |
| | LA31 | 0.5 | 0.5 | 0.5 | 0.5 | 1 | 0.5 | 0.5 |
| | GA80 | — | — | 0.05 | 0.05 | — | — | — |
| | TPD | — | — | 0.05 | 0.05 | — | — | — |
| | GP | — | — | 0.1 | 0.1 | — | — | — |
| | Tin1577 | — | — | 0.3 | 0.3 | — | — | — |
| | LA52 | — | — | 0.05 | 0.05 | — | — | — |
| | NA11 | — | — | 0.3 | 0.3 | — | — | — |
| Composition | D101 | 98.3 | 98.3 | 98.3 | 98.3 | 98.3 | 98.3 | 98.3 |
| of base | DY33-719 (volume average | 0.7 | 0.7 | 0.7 | 0.7 | 0.7 | 0.7 | 0.7 |
| layer | particle diameter: 2-3 μm) | | | | | | | |
| | SBX4 (volume average | 0.7 | 0.7 | 0.7 | 0.7 | 0.7 | 0.7 | 0.7 |
| | particle diameter: 4 μm) | | | | | | | |
| | GA80 | 0.05 | 0.05 | 0.05 | 0.05 | 0.05 | 0.05 | 0.05 |
| | TPD | 0.05 | 0.05 | 0.05 | 0.05 | 0.05 | 0.05 | 0.05 |
| | GP | 0.1 | 0.1 | 0.1 | 0.1 | 0.1 | 0.1 | 0.1 |
| | LA31 | 0.05 | 0.05 | 0.05 | 0.05 | 0.05 | 0.05 | 0.05 |
| | LA52 | 0.05 | 0.05 | 0.05 | 0.05 | 0.05 | 0.05 | 0.05 |
| | NA11 | 0.3 | 0.3 | 0.3 | 0.3 | 0.3 | 0.3 | 0.3 |
| | PSN | 0.0015 | 0.0015 | 0.0015 | 0.0015 | 0.0015 | 0.0015 | 0.0015 |

(Unit of numerical value: parts by mass)

TABLE 2

| | | | Example | Example | Example | Example | Comparative | Comparative | Comparative |
|---|---|---|---|---|---|---|---|---|---|
| | | | 1 | 2 | 3 | 4 | Example 1 | Example 2 | Example 3 |
| Thickness S (mm) of light diffuser plate | | | 2.1 | 2.1 | 2.0 | 2.0 | 2.1 | 2.1 | 2.1 |
| Thickness T (thickness of only one side) | | | 0.05 | 0.05 | 0.05 | 0.05 | 0.05 | 0.05 | 0.05 |
| (mm) of surface layer | | | | | | | | | |
| Total light transmittance (%) | | | 60.0 | 59.9 | 61.9 | 58.9 | 61.0 | 60.7 | 59.6 |
| Diffused light transmittance (%) | | | 59.5 | 59.4 | 61.4 | 58.4 | 60.4 | 60.1 | 59.1 |
| Haze value (%) | | | 99.2 | 99.2 | 99.2 | 99.2 | 99.0 | 99.0 | 99.2 |
| Pencil hardness | | | F | F | H | F | B | B | B |
| Measurement | Initial | Yellowness | 3.6 | 3.5 | 4.5 | 3.3 | 4.0 | 3.7 | 3.3 |
| of spectral | | YI | | | | | | | |
| transmittance | | Chromaticity | 0.3135 | 0.3134 | 0.3143 | 0.3131 | 0.3138 | 0.3136 | 0.3131 |
| | | x | | | | | | | |
| | | Chromaticity | 0.3188 | 0.3188 | 0.3197 | 0.3188 | 0.3191 | 0.3189 | 0.3187 |
| | | y | | | | | | | |
| | Change | ΔYI | — | — | 1.9 | 0.7 | — | — | — |
| | amount | Δx | — | — | 0.002 | 0.001 | — | — | — |
| | after | Δy | — | — | 0.003 | 0.001 | — | — | — |
| | irradiation | | | | | | | | |
| | with | | | | | | | | |
| | light for | | | | | | | | |
| | 715 hours | | | | | | | | |
| | Change | ΔYI | — | — | 8.8 | 3.1 | — | — | — |
| | amount | Δx | — | — | 0.008 | 0.002 | — | — | — |
| | after | Δy | — | — | 0.011 | 0.004 | — | — | — |
| | irradiation | | | | | | | | |
| | with | | | | | | | | |
| | light for | | | | | | | | |
| | 1,260 | | | | | | | | |
| | hours | | | | | | | | |

### Measurement of Total Light Transmittance

Total light transmittance (%) of the light diffuser plate was measured in accordance to JIS K7361-1997.

### Measurement of Diffused Light Transmittance

Diffused light transmittance (%) of the light diffuser plate was measured in accordance to JIS K7136-2000.

### Measurement of Haze Value

Haze value (%) of the light diffuser plate was measured in accordance to JIS K7136-2000.

### Measurement of Pencil Hardness

Pencil hardness of the light diffuser plate was measured in accordance to JIS K5600-5-4-1999. The pencil hardness is as follows: H>F>HB>B

### Measurement of Yellowness YI, Chromaticity x and Chromaticity y by Measurement of Spectral Transmittance

Using an auto spectrophotometer equipped with an integrator (“UV-4000” manufactured by Hitachi, Ltd.), spectral transmittance at a wavelength within a range from 380 to 780 nm of the light diffuser plate was measured and yellowness YI, chromaticity x and chromaticity y were respectively calculated based on the spectral transmittance.

### Evaluation of Light Resistance (Mercury Lamp Irradiation Test)

The light diffuser plate was disposed in an oven equipped with a mercury lamp and was irradiated with ultraviolet light from the mercury lamp under the condition of 75° C. In the same manner as described above, the spectral transmittance after irradiation with light for 715 hours was measured, and then yellowness YI, chromaticity x and chromaticity y after irradiation with light for 715 hours were respectively determined based on the spectral transmittance and a difference before and after irradiation with light (change amount) (ΔYI, Δx, Δy) was calculated. Furthermore, the spectral transmittance after 1,260 hours have passed since the beginning of irradiation with ultraviolet light was measured in the same manner as described above, and then yellowness YI, chromaticity x and chromaticity y after irradiation with light for 1,260 hours were respectively determined based on the spectral transmittance and a difference before and after irradiation with light (change amount) (ΔYI, Δx, Δy) was calculated. Irradiation light from the mercury lamp showed a light intensity of 0.3 to 0.5 mW/cm² at 365 nm and a light intensity of 0.9 to 1.2 mW/cm² at 405 nm.

As is apparent from the tables, the light diffuser plates of Examples 1 to 4 of the present invention had sufficient surface hardness.

In contrast, the light diffuser plate comprising a surface layer, which does not contain particles having a volume average particle diameter of 10 to 200 μm, of Comparative Example 1 had insufficient surface hardness. Also, the light diffuser plates comprising a surface layer containing particles having a volume average particle diameter of 4 μm of Comparative Examples 2 and 3 had insufficient surface hardness.

### INDUSTRIAL APPLICABILITY

The light diffuser plate of the present invention can be preferably used as the light diffuser plate for a surface emission light source apparatus, but is not restricted to this application. The surface emission light source apparatus of the present invention can be preferably used as the backlight for a liquid crystal display apparatus, but is not restricted to this application.

The present application has been filed claiming the Paris Convention priority based on the Japanese patent application Nos. 2007-023684 (filed on Feb. 2, 2007), the entire content of which is herein incorporated by reference.

What is claimed is:

1. A light diffuser plate comprising:
a base layer which is made of a resin composition containing light diffusing particles in an amount of 0.1 parts by mass or more and less than 5 parts by mass based on 100 parts by mass of a propylene polymer, and
a surface layer which is integrally laminated on one or both surfaces of the base layer, wherein
the surface layer is made of a resin composition containing particles having a volume average particle diameter of 10 to 200 μm in an amount of 5 to 50 parts by mass based on 100 parts by mass of a propylene polymer.

2. The light diffuser plate according to claim 1, wherein the resin composition constituting the surface layer further contains an ultraviolet absorber in an amount of 0.1 to 5 parts by mass based on 100 parts by mass of the propylene polymer.

3. The light diffuser plate according to claim 1 or 2, wherein the volume average particle diameter of the light diffusing particles is 0.5 μm or more and less than 10 μm.

4. The light diffuser plate according to any one of claims 1 to 2, wherein the thickness of the surface layer is from 10 to 500 μm and the entire thickness is from 1 to 3 mm.

5. A surface emission light source apparatus comprising the light diffuser plate according to any one of claims 1 to 2 and a plurality of light sources disposed on the back side of the light diffuser plate.

6. A liquid crystal display apparatus comprising the light diffuser plate according to any one of claims 1 to 2, a plurality of light sources disposed on the back side of the light diffuser plate, and a liquid crystal panel disposed on the front side of the light diffuser plate.
